(19) United States
(12) Patent Application Publication
(10) Pub. No.: US 2026/0323733 A1
(43) Pub. Date: Oct. 15, 2026

(54) HANDLING OF NEW RADIO CELL GROUP IDENTIFIER ALLOCATION FOR MOBILE INTEGRATED ACCESS AND BACKHAUL NODES

(71) Applicant: Telefonaktiebolaget LM Ericsson (publ), Stockholm (SE)

(72) Inventors: Filip BARAC, Huddinge (SE); Antonino ORSINO, Kirkkonummi (FI); Boris DORTSCHY, Vendelsö (SE); Junfeng WANG, Ottawa (CA); Gautham Nayak SEETANADI, Stockholm (SE)

(73) Assignee: Telefonaktiebolaget LM Ericsson (publ), Stockholm (SE)

(21) Appl. No.: 19/482,652

(22) PCT Filed: May 8, 2024
(86) PCT No.: PCT/IB2024/054502

§ 371 Date: Nov. 7, 2025

Related U.S. Application Data
(60) Provisional application No. 63/464,928, filed on May 8, 2023.

(51) Int. Cl. H04W 76/11; H04L 5/00; H04W 76/20

(52) U.S. Cl. CPC H04W 76/11; H04L 5/0053; H04W 76/20

(57) ABSTRACT

A first network node, in a communications network that includes a second network node, can transmit a first message to the second network node. The first message includes an indication of a first cell identifier configured by a third network node and an indication that the second network node avoid using the first cell identifier. The first network node further receives a second message from the second network node, the second message including an indication of a second cell identifier.

### TECHNICAL FIELD

The present disclosure is related to wireless communication systems and more particularly to handling of new radio cell group identifier (“CGI”) allocation for mobile integrated access and backhaul nodes.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

5G networks are being designed and deployed using a dense deployment of small cells in order to simultaneously serve more UEs with higher throughput and lower delay. However, building from scratch a completely new infrastructure is costly and takes time. Deploying a wireless backhaul can be an economically and technically viable approach to enable a flexible and dense network. This solution was standardized in 3GPP Release 16, under the term Integrated Access and Backhaul (“IAB”), to support wireless relaying in next generation radio access network (“NG-RAN”) and has continued in Release 17.

In some examples, IAB is based on a central unit (“CU”)-distributed unit (“DU”) split gNB architecture that was standardized in Release 16. The CU can include a radio resource control (“RRC”) and a packet data convergence protocol (“PCDP”), whereas the DU executes the radio link control (“RLC”) and multiple access control (“MAC”). The F1 interface connects the CU and the DU. The CU-DU split facilitates separate physical CU and DU, while also allowing a single CU to be connected to multiple DUs. FIG. 2 illustrates an example of the basic architecture of an IAB.

### SUMMARY

According to some embodiments, a method of operating a first network node is provided. The first network node is included in a communications network that includes a second network node. The method includes transmitting a first message to the second network node. The first message includes an indication of a first cell identifier configured by a third network node and an indication that the second network node avoid using the first cell identifier. The method further includes receiving a second message from the second network node, the second message including an indication of a second cell identifier.

According to other embodiments, a method of operating a second network node is provided. The second network node is in a communications network that includes a first network node. The method includes receiving a first message from the first network node. The first message includes an indication of a first cell identifier configured by a third network node and an indication that the second network node avoid using the first cell identifier. The method further includes transmitting a second message to the first network node, the second message including an indication of a second cell identifier.

According to other embodiments, a method of operating a third network node is provided. The third network node is included in a communications network that includes a first network node and a second network node. The method includes determining a first cell identifier. The method further includes transmitting an indication of the first cell identifier to the first network node. The method further includes receiving an indication that the first cell identifier is invalid.

According to other embodiments, a network node, a DU, a CU, a system, or a host is provided to perform one of the above methods.

Certain aspects of the disclosure may provide technical advantages. In some embodiments, signalling enhancements support the CU-based NCGI allocation in a backwards compatible manner.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a block diagram illustrating an example of an IAB architecture with donor and child nodes;

FIG. 3 is a schematic diagram illustrating an example of a mobile IAB-node that involved intra-donor, inter-donor (same CU) and inter CU;

FIG. 4 is a block diagram illustrating an example of a mIAB-MT with two logical DUs with F1 connections to different donor CUs;

FIGS. 5-7 are block diagrams illustrating examples of operations performed by a network node in accordance with some embodiments;

FIG. 8 is a block diagram of a communication system in accordance with some embodiments;

FIG. 9 is a block diagram of a user equipment in accordance with some embodiments;

FIG. 10 is a block diagram of a network node in accordance with some embodiments;

FIG. 11 is a block diagram of a host, which may be an embodiment of the host of FIG. 8, in accordance with some embodiments;

FIG. 12 is a block diagram of a virtualization environment in accordance with some embodiments; and

FIG. 13 shows a communication diagram of a host communicating via a network node with a user equipment over a partially wireless connection in accordance with some embodiments.

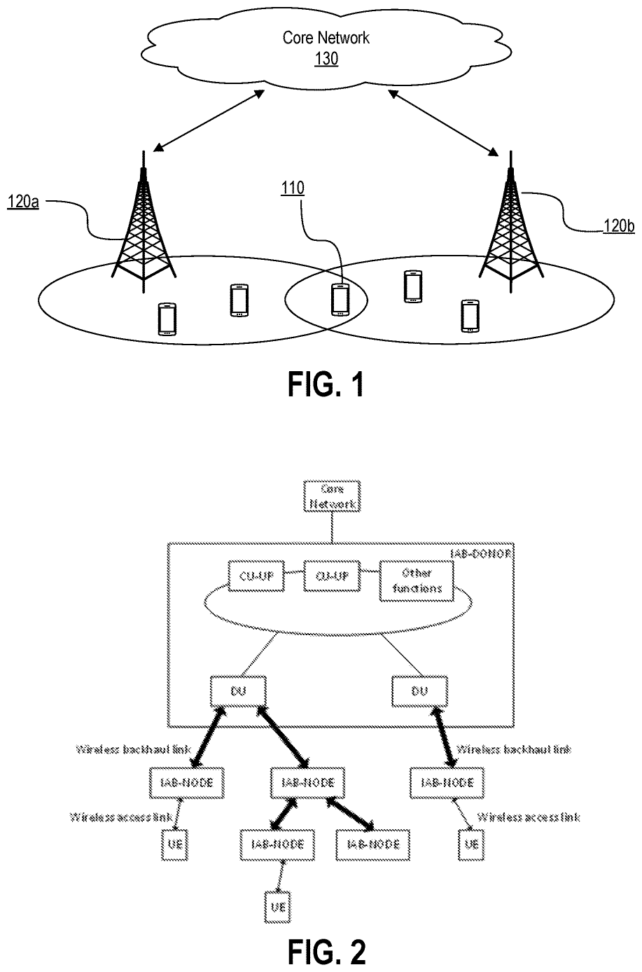

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

FIG. 2 illustrates an example of a single IAB donor connected to the core network. The IAB donor serves three direct IAB child nodes through two collocated DUs at the donor for wireless backhauling. The centre IAB node in turn serves two IAB nodes through wireless backhaul. All IAB nodes in the figure perform traffic backhauling for both related to UEs connected to it, and other downstream IAB nodes.

In some examples, the main components of the IAB architecture are: 1) and IAB node; and 2) an IAB donor. The IAB Node can be a node that allows wireless access to the UEs while also backhauling the traffic to other nodes. The IAB node consists of an IAB-DU that provides access to connected UEs. The node also consists of a mobile termination (“MT”) that connects to other IAB nodes or donors in the uplink direction for backhaul.

The IAB Donor can be a node that provides UEs an interface to the core network and wireless functionality to other IAB-nodes to backhaul their traffic to the core network.

A defining feature of IAB is the use of wireless spectrum for both access of UEs and backhauling of data through IAB donors. Thus, there needs to be clear separation of access and backhaul resources to avoid interference between them. This separation of access and backhaul resources cannot be handled during network planning due to dynamic nature of IAB.

Un Release 16, IAB was standardized with basic support for multi-hop multi-path backhaul for directed acyclic graph (“DAG”) topology, no mesh-based topology was supported. Rel-16 also supports QoS prioritization of backhaul traffic and flexible resource usage between access and backhaul. Discussions in Release 17 are on topology enhancements for IAB with partial migration of IAB nodes for RLF recovery and load balancing.

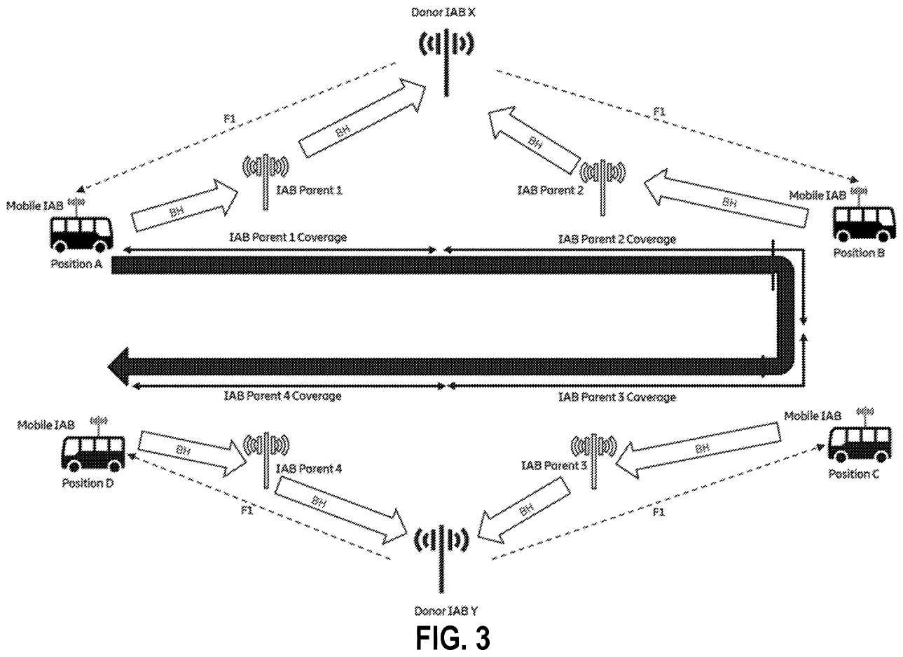

In Release 18, it is expected that the different RAN groups will work towards enhancing functionality of IAB through Mobile IAB providing 5G coverage enhancement to onboard and surrounding UEs. The initial use cases for mobile-IAB/VMR (vehicle mounted relay) are expected to be based on 3GPP TR 22.839v18.1.0 . FIG. 3 shows a mobile IAB mounted on a bus travelling on a route that is covered by 4 different parent IAB nodes (IAB Parent 1,2,3,4). The parent nodes backhaul their traffic through 2 donor nodes (Donor IAB X, Y).

FIG. 3 illustrates an example of a mobile IAB-node, which involves Intra-Donor, Inter-Donor (same CU) and Inter CU.

An IAB node has an IAB-DU that provides access to UEs around it and an IAB-MT that provides a backhaul connection of the IAB node to its parent(s) and the rest of the network. The parent IAB nodes consist of IAB-DUs that provide access to UEs and the mobile IAB present in their coverage. IAB-nodes also consist of an IAB-MT that backhauls its traffic together with traffic from the mobile IAB node. Finally, the two donor nodes consist of DU that provides access and CU that is connected to the core network. The CUs in both donor nodes maintain a F1 connection to IAB-DUs under it.

When the mobile IAB node moves from one geographical area to the next, it passes through different areas covered by various cells of stationary parent nodes.

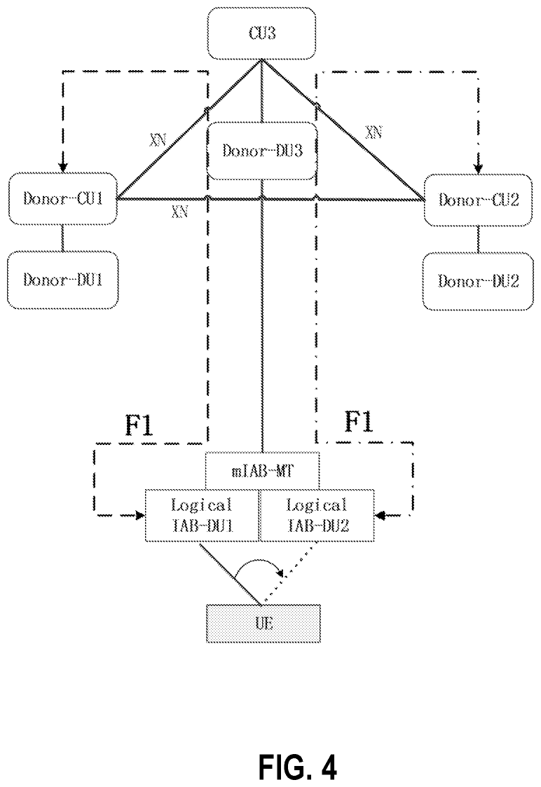

In general, 3GPP assumes that the mIAB-DU migration between different donor-CUs will be realized by powering up a second logical mIAB-DU in an mIAB node (IAB-DU2), that will establish F1 connection to the target donor CU for mIAB-DU migration (IAB-donor-CU2). Then, the UEs served by the mIAB-node will be handed over from a cell of mIAB-DU1 controlled by source donor CU (CU1) to a cell of mIAB-DU2 controlled by target donor CU (CU2). The two cells reside on the same physical IAB-node but they each have a separate F1 connection to IAB-donor-CU1 and IAB-donor-CU2, respectively (e.g., FIG. 4). After UEs are handed over between the mIAB-DU1 and mIAB-DU2, the F1 connection between the mIAB-DU1 and IAB-donor-CU1 is released.

Plug and connect (“PnC”) is a procedure that a network node uses to initiate an IP connection to OAM network. Plug and connect to OAM system includes the steps of initial IP autoconfiguration, Certificate enrolment, Establishing a secure connection to SeGW and Establishing a secure connection to Software configuration server (“SCS”). The initial IP autoconfiguration obtains client IP configuration and IP address or Fully Qualified Domain Names (“FQDN”) of CA/RA, SeGW and SCS via DHCP request. To perform CA/RA enrolment, the Network Element may be provisioned with operator's root certificate if the root certificate is not obtained during CMPv2 protocol (TS 33.310v18.0.0 ). 3GPP TS 28.314, TS 28.315 and TS 28.315 specify stage 1/2/3 descriptions for the Plug and Connect.

A NCGI (sometimes referred to as the NR CGI) is an essential parameter of every NR cell.

In 3GPP specifications, the terms “NR CGI” and “NCGI” can be used interchangeably. For example, the former term is used in TS 38.473, and the latter one is used in TS 38.300.

The NCGI can include a PLMN Identity and the NR Cell Identity (NCI). The NCI consists of the gNB-ID and the cellLocalId.

There currently exist certain challenges. According to legacy specifications, the NCGIs of the cells to be served by a DU are configured at the DU by the OAM. At F1 setup towards a CU, the DU informs the CU about the NCGIs configured at the DU.

In the Mobile IAB Rel-18 Work Item, the 3GPP RAN3 working group is currently discussing whether, upon mobile IAB-DU (mIAB-DU) inter-donor migration, the NCGIs of cells to be served by a mobile IAB-DU after the migration can also be assigned to the mIAB-DU by the target donor CU for the mIAB-DU migration (as an alternative to the legacy OAM-based assignment). The following “for further study” item was captured in the RAN3 #119-bis-e chairman notes: “For DU-migration, the target mIAB-DU-cell's NCGI can be configured via OAM and optionally (re-)configured by the target mIAB-DU's CU when NCGI confliction happens?”

In case RAN3 agrees that a donor CU may assign NCGIs to mIAB-DUs, at least the following issues will arise:

Given that the standard will, in this case, allow two different options for NCGI allocation (OAM-based and CU-based), at every mIAB-DU migration, it will be unclear to both the target CU and the OAM which of the options should be used, i.e., which of them should assign the NCGIs to the mIAB-DU.

The current F1 SETUP REQUEST message sent from the DU to the target CU to set up the F1 connection contains, as a mandatory IE, the list of NCGIs for the cells to be served by the DU. The reason is that, in legacy specifications, it is expected that the OAM assigns the NCGIs to a DU (and mIAB-DU). Hence, the current signalling is incompatible with CU-based NCGI allocation. Therefore, in case the OAM does not assign any NCGI to the DU, the DU will not include any NCGI value in the F1 SETUP REQUEST and the CU may consider the request to establish an F1 connection as not valid.

As of today, it is unclear how to address the above issues.

In some embodiments, the NCGI is provided to the mIAB-DU. However, in other embodiments, the mIAB-DU is provided with some or all of the constituents of the NCGI (PLMN ID, gNB ID, cellLocalId) separately, from which the mIAB-DU can infer/construct the NCGI.

In additional or alternative embodiments, more than one NR CGI is assigned to the mIAB-DU and the mIAB-DU may receive either one or more NR CGIs.

The terms “target donor-CU”, “CU” and “target CU” can be used interchangeably.

The examples of implementation in the specifications presented in some embodiments are non-limiting, meaning that the newly proposed IE names need not necessarily be the same as those exemplified. Further, the placement examples of the new IEs inside the existing IEs is non-limiting as well.

In additional or alternative embodiments, these innovations apply to NR as well as future RATs such as beyond 3GPP Rel-18 .

The terms “OAM”, “OAM system” can be used interchangeably.

The terms “second logical mIAB-DU” or “mIAB-DU2” can be used interchangeably.

In additional or alternative embodiments, innovations are described as appliable to mobile IAB-DU, but can be equally applicable to a static IAB-DU as well as to a “regular” (i.e., non-IAB) DU.

In the scenario of interest, an mIAB-DU is migrating between the source and the target donor CU. At every mIAB-DU migration, the logical mIAB-DU entity in the mIAB-node that was active prior to mIAB-DU migration is referred to as the “first logical mIAB-DU” or “mIAB-DU1”. The logical mIAB-DU entity that is powered up as a part of the mIAB-DU migration (as explained above), and that establishes the F1 connection with the target CU, is referred to as the “second logical mIAB-DU” or “mIAB-DU2”.

In the context of the present invention and the above scenario, the term “mIAB-DU” pertains to the second logical mIAB-DU, unless stated otherwise.

Tin some embodiments, the NCGI is provided to the mIAB-DU, but, in some variants, the mIAB-DU can be provided with some or all of the constituents of the NCGI (PLMN ID, gNB ID, cellLocalId) separately, from which the mIAB-DU can infer/construct the NCGI.

For the mIAB-DU to be able serve the UEs, it needs to have cells configured, and each cell needs to have an NR CGI. As mentioned above, there may be two options for the second logical mIAB-DU to obtain the NCGIs for its served cells (the legacy one, i.e., OAM-based, and a new one, i.e., CU-based), However, the CU-based option is incompatible with the existing F1 signalling for F1 setup. The reason is that, according to current specifications, the mIAB-DU shall, in the F1 SETUP REQUEST message, indicate to the CU the NR CGIs (i.e., the NCGIs) that it received from the OAM, whereas, in the CU-based option the mIAB-DU cannot include the NR CGIs (i.e., the NCGI) in the F1 SETUP REQUEST because it is yet to receive them from the CU.

Hence, the focus of this invention are the signalling enhancements to the existing signalling so that the mIAB-DU can obtain the NR CGIs from the CU by using the existing signalling in a backwards-compatible way. In some embodiments, there are signalling enhancements for communication between: 1) The mIAB-DU and the CU; or 2) the mIAB-DU and the OAM system. When the signalling enhancements are for communication between the mIAB-DU and the CU, the enhancements impact the TS 38.473 specification. Herein, there are two sub-groups of enhancements, where each example of one subgroup can be combined with any of the examples in the other sub-group: 1) The enhancements for F1AP messages sent from the DU to the CU; and 2) The enhancements for F1AP messages sent from the CU to the DU. When the signalling enhancements are for communication between the mIAB-DU and the CU, the enhancements impact the TS 28.541 specification.

Embodiments related to F1 signalling between the mIAB-DU and target donor CU are described below.

In some embodiments, the mIAB-DU sends the F1 SETUP REQUEST message to the target CU. In additional or alternative embodiments, the mIAB-DU includes in the F1 SETUP REQUEST message an additional IE that may indicate one or more of the following: 1) An indication that the legacy NR CGIs included in the message should be ignored and that the CU should assign the NR CGIs instead; and 2) A request to the CU to assign an NR CGIs. In such a case, if this request is present in the F1 SETUP REQUEST message the CU will automatically ignore the legacy field where the DU indicates the NR CGIs to the CU.

In additional or alternative embodiments, the new IE may be included into the F1 SETUP REQUEST in one of the following ways (non-limiting examples). In some examples, the IE is included (e.g., in the end of the message). In additional or alternative examples, the IE is included in each item of the existing gNB-DU Served Cells List IE. So, one or more instances of the IE can be present in the F1 SETUP REQUEST, where their number equals the number of items in the gNB-DU Served Cells List IE. In additional or alternative examples, the IE is included inside the existing Served Cell Information IE, whereas one instance of Served Cell Information IE is present in each item of the gNB-DU Served Cells List IE. So, one or more instances of the IE can be present in the F1 SETUP REQUEST, where their number equals the number of items in the gNB-DU Served Cells List IE.

The above may hold for inclusion of any new F1AP IE proposed by this invention (e.g., the newly proposed Request NR CGI from CU IE) into any F1AP message whose enhancement is proposed in this invention.

In some embodiments, the NR CGIs included by the mIAB-DU are dummy values. In another variant, the NR CGIs included by the mIAB-DU are default/reserved/special/pre-defined/hard-coded values.

In additional or alternative embodiments, no new IE is included in the F1 SETUP REQUEST, but, instead, the values indicated in the NR CGI IE in the F1 SETUP REQUEST are some default/reserved/special/pre-defined/hard-coded values which indicate that the NR CGI values in the same message are dummy values, and that the NR CGI assignment should be done by the CU instead. So, based on these values the target CU understands that it should assign the NR CGIs to the mIAB-DU.

In additional or alternative embodiments, the OAM will assign the NCGIs to the mIAB-DU, and the mIAB-DU will indicate them to the target CU, as per legacy, in the F1 SETUP REQUEST message. If the target CU determines that some or all NCGIs indicated are already occupied (e.g., used for other existing cells served by the CU), the CU will allocate the new NCGIs to the mIAB-DU that are to replace those NCGIs already occupied, and the CU will indicate these updated NCGIs to the mIAB-DU, as described below in subsequent stepss. In another variant, if there is at least one NCGI collision, all the NCGIs indicated by the mIAB-DU will be replaced by the CU.

In additional or alternative embodiments, the OAM system indicate to both the CU and DU that it is the responsibility of the CU to assign NR CGIs to that particular DU. In this case, the OAM system may indicate to the CU which particular DU expects the NR CGIs to be assigned by the CU.

In some examples, it does not really matter what value the DU indicate in the NR CGI IE within the F1 SETUP REQUEST message as the CU will automatically ignore that IE.

In some embodiments, the target CU assigns the NR CGIs. After receiving the F1 SETUP REQUEST message including one or more instances of the newly proposed IE or other indication to the CU described above in Step 1 (e.g., agreed dummy values), the CU assigns one or more NR CGIs to the mIAB-DU. In additional or alternative embodiments, the number of assigned NR CGIs is equal to the number of dummy NR CGIs indicated by the mIAB-DU. In another variant, the number of assigned NR CGIs is different.

In some embodiments, the target CU sends the F1 SETUP RESPONSE message to the mIAB-DU. In additional or alternative embodiments, in the F1 SETUP RESPONSE sent to the mIAB-DU, the target CU includes the assigned NR CGIs. In addition, for the mIAB-DU to be able to link the (dummy) NR CGIs provided in the F1 SETUP REQUEST with the NR CGIs assigned by the CU, for every assigned NR CGI, the CU indicates the corresponding dummy NR CGI indicated by the mIAB-DU. In some examples, the new IE indicated NR CGIs assigned by the target CU may be included in the F1 SETUP RESPONSE message, in the Cells to be Activated List Item IE.

In additional or alternative embodiments, the new NCGIs indicated by the CU are provided in a list and are sequentially assigned to the dummy NCGI values or mIAB-DU cells.

In additional or alternative embodiments, the gNB-CU allocates the NR CGIs in an already present IE in the F1 SETUP RESPONSE message.

In additional or alternative embodiments, the mIAB-DU receives the NR CGIs from the OAM, and indicates them to the target CU, as per legacy, in the F1 SETUP REQUEST message. However, if the CU decides that itself wants to allocate the NR CGIs (for example in case some of the NR CGIs indicated by the mIAB-DU is already occupied), the CU sends the F1 SETUP RESPONSE message to the mIAB-DU, and the message contains the NR CGIs assigned by the CU. Herein, for every NR CGI assigned by the CU, the corresponding NR CGI indicated by the mIAB-DU is indicated as well.

Embodiments related to the signalling between the mIAB-DU and the OAM system are provided below. These embodiments can be complementary to (i.e., may be used together with) the embodiments described above related to F1AP TS 38.473 signalling.

The TS 28.532 specifies operations and notifications for provisioning management service. The TS 28.541 specifies the NR network resource model (NRM) that contains NRCellDU Information Object Class (IOC). When CU-based NR CGI allocation is used (as proposed by this invention), the second logical mIAB-DU obtains cellLocalId and pLMNInfoList from CU through F1 signalling and then, in one embodiment, indicates to the OAM the value of attribute cellLocalId and pLMNInfoList of NRCellDU through notifications as specified in TS 28.532.

Hence, in some embodiments, a clarification needs to be added to cellLocalId and pLMNInfoList of NRCellDU in TS 28.541 to indicate in CU-based NR CGI allocation, mIAB-DU can update the OAM the cellLocalId and pLMNInfoList through “notifyMOIAttribute ValueChanges” and “notifyMOIChanges” notifications as specified in TS 28.532.

In some embodiments, after receiving the NR CGIs assigned by the target CU, the mIAB-DU indicates the cellLocalId and pLMNInfoList corresponding to these NR CGIs to the OAM. If the NR CGIs have been previously allocated based on OAM provisioned cellLocalId and pLMNInfoList (as stipulated by the legacy) to the mIAB-DU for connecting to this donor CU, the mIAB-DU also indicates, together with cellLocalId and pPLMNInfoList corresponding to each NR CGI allocated by the CU, the OAM provisioned cellLocalId and pPLMInfoList previously used for NR CGI allocation.

In additional or alternative embodiments, instead of enhancing the F1 SETUP REQUEST and F1 SETUP RESPONSE message (proposed above), the GNB-DU CONFIGURATION UPDATE and GNB-DU CONFIGURATION UPDATE ACKNOWLEDGE messages can be used with these proposed enhancements. The former message is sent from the mIAB-DU to the CU, and the CU responds with the latter message.

In additional or alternative embodiments, the GNB-CU CONFIGURATION UPDATE and GNB-CU CONFIGURATION UPDATE ACKNOWLEDGE messages can be used. The former message is sent from the CU to the mIAB-DU, and the mIAB-DU responds with the latter message (confirms the CU-based NR CGI allocation). In this case, after the mIAB-DU has indicated the NR CGIs to the CU, the CU initiates the gNB-CU Configuration Update procedure to update the NR CGIs.

In additional or alternative embodiments,, instead of indicating the NR CGIs to the mIAB-DU by including the new IE into the F1 SETUP RESPONSE message, the assigned NR CGIs are indicated to the mIAB-node via RRC signalling. The mIAB-MT co-located with the mIAB-DU receives the RRC message and passes the NR CGIs to the mIAB-DU, which then includes the NR CGIs into the F1 SETUP REQUEST message towards the target CU. In some examples, the target CU for the mIAB-DU migration is the CU that currently serves the mIAB-MT. In additional or alternative examples, the target CU for the mIAB-DU migration is different from the CU that currently serves the mIAB-MT. In this case, the mIAB-DU's target CU or OAM indicates to the mIAB-MT's CU the NR CGIs for the mIAB-DU, and the mIAB-MT's CU then indicates the NR CGIs to the mIAB-MT via RRC signalling, as described above.

Some embodiments are presented on the example of NR CGI allocation, but it may equally apply to any other parameter assigned to the mIAB-DU by the OAM.

The implementation examples provided can be classified into two groups: 1) The enhancements for signalling between the mIAB-DU and the CU; and 2) The enhancements for signalling between the mIAB-DU and the OAM system. When the enhancements are for signalling between the mIAB-DU and the CU they can impact the TS 38.473 specification. Herein, there are two sub-groups of enhancements, where each example of one subgroup can be combined with any of the examples in the other sub-group: 1) The enhancements for messages sent from the DU to the CU; and 2) The enhancements for messages sent from the CU to the DU. When the enhancements are for signalling between the mIAB-DU and the OAM system, impacting the TS 28.541 specification. The two groups of implementation examples are complementary, meaning that they are both needed and can coexist in an mIAB-DU/CU/OAM implementation. Note that in some implementation examples, the NCGI is referred to as the NR CGI.

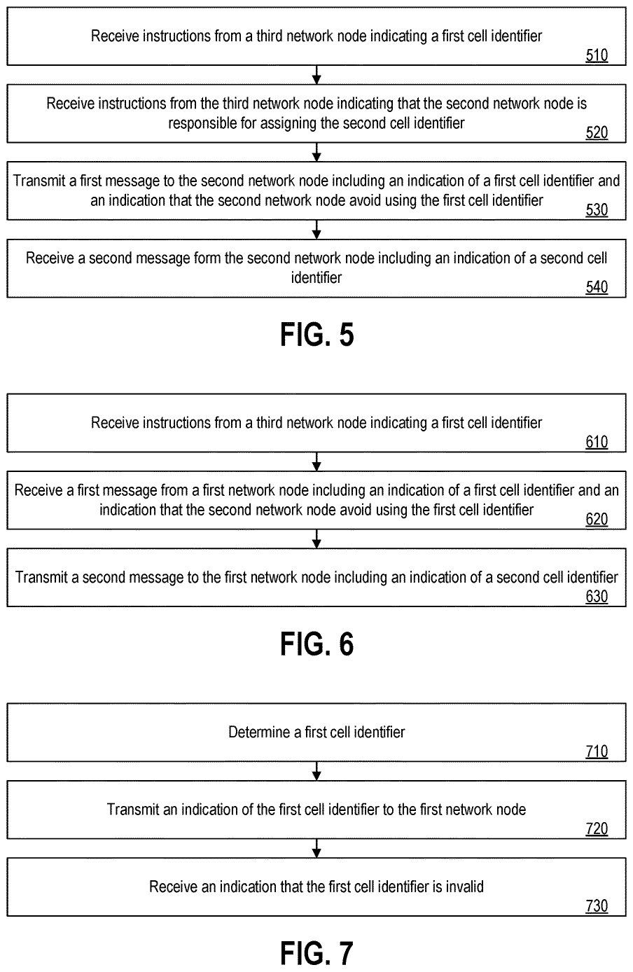

Operations of the RAN node 1000 (implemented using the structure of FIG. 10) will now be discussed with reference to the flow chart of FIGS. 5-7 according to some embodiments of inventive concepts. For example, modules may be stored in memory 1004 of FIG. 10, and these modules may provide instructions so that when the instructions of a module are executed by respective RAN node processing circuitry 920, RAN node 1000 performs respective operations of the flow chart.

Various operations from the flow chart of FIGS. 5-7 may be optional with respect to some embodiments of RAN nodes and related methods.

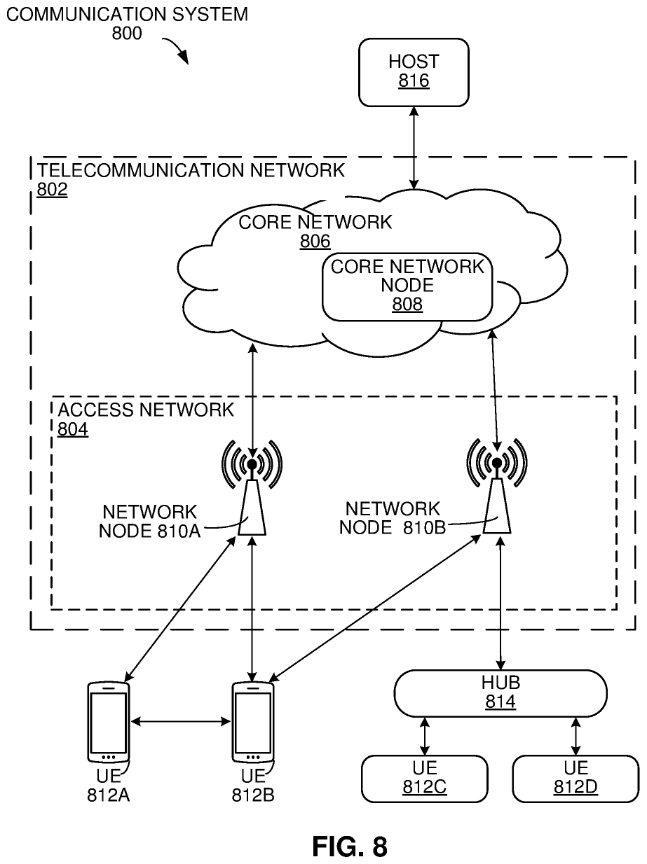

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access node or non-3GPP access point. Moreover, as will be appreciated by those of skill in the art, the network nodes 810 are not necessarily limited to an implementation in which a radio portion and a baseband portion are supplied and integrated by a single vendor. Thus, it will be understood that the network nodes 810 may include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 810 facilitate direct or indirect connection of user equipment (UE), such as by connecting wireless devices 812a, 812b, 812c, and 812d (one or more of which may be generally referred to as UEs 812) to the core network 806 over one or more wireless connections. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

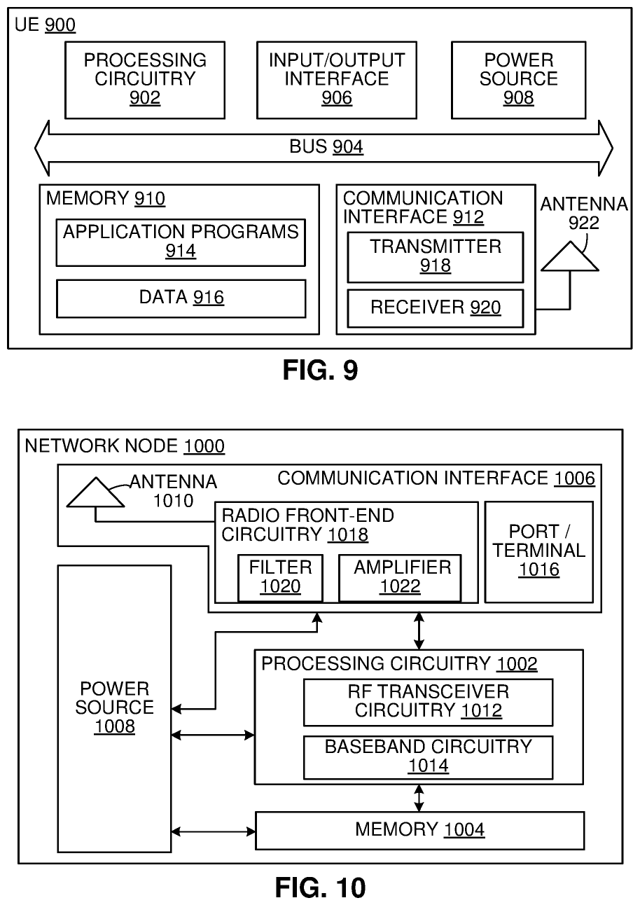

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

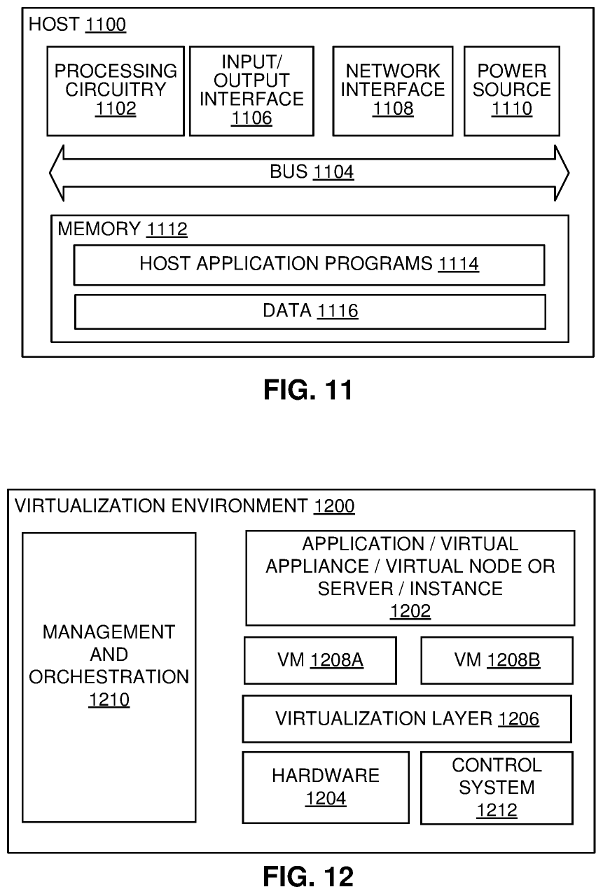

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1200 includes components defined by the O-RAN Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

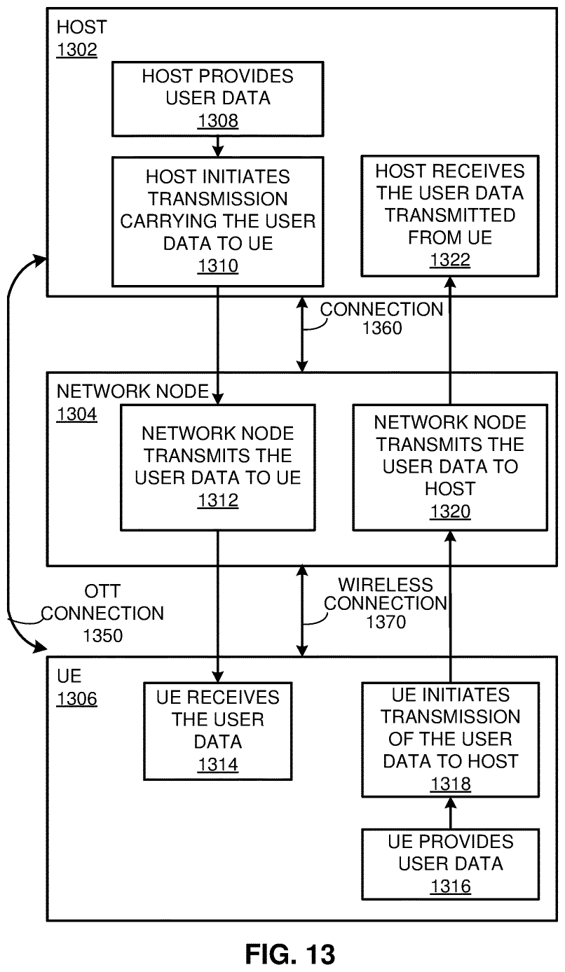

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may allow for signaling enhancements for supporting the CU-based NCGI allocation in a backwards compatible manner.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc. ; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments are described below.

Embodiment 1. A method of operating a first network node, in a communications network that includes a second network node, the method comprising:
transmitting (530) a first message to the second network node, the first message including:
an indication of a first cell identifier configured by a third network node; and
an indication that the second network node avoid using the first cell identifier; and
receiving (540) a second message from the second network node, the second message including an indication of a second cell identifier.

Embodiment 2. The method of Embodiment 1, wherein the indication that the second node avoid using the first cell identifier comprises a request that the second network node assign the second cell identifier.

Embodiment 3. The method of any of Embodiments 1-2, wherein the first cell identifier and the second cell identifier each comprises a new radio, NR, cell global identity, CGI.

Embodiment 4. The method of any of Embodiments 1-3, wherein the first message comprises a F1 SETUP REQUEST message, and
wherein the second message comprises a F1 SETUP RESPONSE message.

Embodiment 5. The method of any of Embodiments 1-3, wherein the first message comprises a GNB-DU CONFIGURATION UPDATE message, and
wherein the second message comprises a GNB-DU CONFIGURATION UPDATE ACKNOWLEDGE message.

Embodiment 6. The method of any of Embodiments 1-3, wherein the first message comprises a GNB-CU CONFIGURATION UPDATE message, and
wherein the second message comprises a GNB-CU CONFIGURATION UPDATE ACKNOWLEDGE message.

Embodiment 7. The method of any of Embodiments 1-3, wherein the first message comprises a radio resource control, RRC, signal.

Embodiment 8. The method of any of Embodiments 1-7, wherein the first message includes an information element, IE, that includes the indication of the first cell identifier and the indication that the second network node avoid using the first cell identifier.

Embodiment 9. The method of Embodiment 8, wherein the IE is included at an end of the first message.

Embodiment 10. The method of Embodiment 8, wherein the IE is included in each item of a Served Cells List IE.

Embodiment 11. The method of Embodiment 8, wherein the IE is included in a Served Cell Information IE.

Embodiment 12. The method of any of Embodiments 8-11, wherein the indication of the second cell identifier is included in a Cells to be Activated List Item IE.

Embodiment 13. The method of any of Embodiments 1-12, further comprising:
receiving (520) instructions from the third network node indicating that the second network node is responsible for assigning the second cell identifier.

Embodiment 14. The method of any of Embodiments 13, further comprising:
receiving (510) instructions from the third network node indicating the first cell identifier.

Embodiment 15A. The method of any of Embodiments 1-14, further comprising:
transmitting (550) a third message to the third network node, the third message including a condition added to a cellLocalID and a pLMNInfoList of NRCellDU to indicate that they are not required in CU-based NR CGI allocation.

Embodiment 15B. The method of any of Embodiments 1-14, wherein the first network node is configured to provide a distributed unit, DU,
wherein the second network node is configured to provide a central unit, CU, and
wherein the third network node is configured to provide an operation and maintenance, OAM.

Embodiment 16. The method of Embodiment 15, wherein the DU comprises at least one of:
a mobile integrated access and backhaul DU, mIAB-DU; and
a IAB-mobile termination, IAM-MT.

Embodiment 17. A method of operating a second network node, in a communications network that includes a first network node, the method comprising:
receiving (620) a first message from the first network node, the first message including:
   an indication of a first cell identifier configured by a third network node; and
   an indication that the second network node avoid using the first cell identifier; and
transmitting (630) a second message to the first network node, the second message including an indication of a second cell identifier.

Embodiment 18. The method of Embodiment 17, wherein the indication that the second node avoid using the first cell identifier comprises a request that the second network node assign the second cell identifier.

Embodiment 19. The method of any of Embodiments 17-18, wherein the first cell identifier and the second cell identifier each comprises a new radio, NR, cell global identity, CGI.

Embodiment 20. The method of any of Embodiments 17-19, wherein the first message comprises a F1 SETUP REQUEST message, and
wherein the second message comprises a F1 SETUP RESPONSE message.

Embodiment 21. The method of any of Embodiments 17-19, wherein the first message comprises a GNB-DU CONFIGURATION UPDATE message, and
wherein the second message comprises a GNB-DU CONFIGURATION UPDATE ACKNOWLEDGE message.

Embodiment 22. The method of any of Embodiments 17-19, wherein the first message comprises a GNB-CU CONFIGURATION UPDATE message, and
wherein the second message comprises a GNB-CU CONFIGURATION UPDATE ACKNOWLEDGE message.

Embodiment 23. The method of any of Embodiments 17-19, wherein the first message comprises a radio resource control, RRC, signal.

Embodiment 24. The method of any of Embodiments 17-23, wherein the first message includes an information element, IE, that includes the indication of the first cell identifier and the indication that the second network node avoid using the first cell identifier.

Embodiment 25. The method of Embodiment 24, wherein the IE is included at an end of the first message.

Embodiment 26. The method of Embodiment 24, wherein the IE is included in each item of a Served Cells List IE.

Embodiment 27. The method of Embodiment 24, wherein the IE is included in a Served Cell Information IE.

Embodiment 28. The method of any of Embodiments 24-27, wherein the indication of the second cell identifier is included in a Cells to be Activated List Item IE.

Embodiment 29. The method of any of Embodiments 17-28, further comprisig:
receiving (610) instructions from the third network node indicating that the second network node is responsible for assigning the second cell identifier.

Embodiment 30. The method of any of Embodiments 17-29, wherein the first network node is configured to provide a distributed unit, DU,
wherein the second network node is configured to provide a central unit, CU, and
wherein the third network node is configured to provide an operation and maintenance, OAM.

Embodiment 31. The method of Embodiment 30, wherein the DU comprises at least one of:
a mobile integrated access and backhaul DU, mIAB-DU; and
a IAB-mobile termination, IAM-MT.

Embodiment 32. A method of operating a third network node, in a communications network that includes a first network node and a second network node, the method comprising:
determining (710) a first cell identifier;
transmitting (720) an indication of the first cell identifier to the first network node; and
receiving (730) an indication that the first cell identifier is invalid.

Embodiment 33. The method of Embodiment 32, wherein receiving the indication that the first cell identifier is invalid comprises receiving an indication of a second cell identifier assigned by the second network node.

Embodiment 34. The method of any of Embodiments 32-33, wherein the first network node is configured to provide a distributed unit, DU,
wherein the second network node is configured to provide a central unit, CU, and
wherein the third network node is configured to provide an operation and maintenance, OAM.

Embodiment 35. The method of Embodiment 34, wherein the DU comprises at least one of:
a mobile integrated access and backhaul DU, mIAB-DU; and
a IAB-mobile termination, IAM-MT.

Embodiment 36. A network node (1000), the network node comprising:
processing circuitry (1002); and
memory (1004) coupled to the processing circuitry and having instructions stored therein that are executable by the processing circuitry to cause the network node to perform operations comprising any of the operations of Embodiments 1-35.

Embodiment 37. A computer program comprising program code to be executed by processing circuitry (1002) of a network node (1000), whereby execution of the program code causes the network node to perform operations comprising any operations of Embodiments 1-35.

Embodiment 38. A computer program product comprising a non-transitory storage medium (1004) including program code to be executed by processing circuitry (1002) of a network node (1000), whereby execution of the program code causes the network node to perform operations comprising any operations of Embodiments 1-35.

Embodiment 39. A non-transitory computer-readable medium having instructions stored therein that are executable by processing circuitry (1002) of a network node (1000) to cause the network node to perform operations comprising any of the operations of Embodiments 1-35.

Embodiment 40. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
   transmitting (530) a first message to the second network node, the first message including:
      an indication of a first cell identifier configured by a third network node; and
      an indication that the second network node avoid using the first cell identifier; and
   receiving (540) a second message from the second network node, the second message including an indication of a second cell identifier.

Embodiment 41. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 42. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the following operations to transmit the user data from the host to the UE:
   transmitting (530) a first message to the second network node, the first message including:
      an indication of a first cell identifier configured by a third network node; and
      an indication that the second network node avoid using the first cell identifier; and
   receiving (540) a second message from the second network node, the second message including an indication of a second cell identifier.

Embodiment 43. The method of the previous embodiment, further comprising, at the network node, transmitting the user data provided by the host for the UE.

Embodiment 44. The method of any of the previous 2 embodiments, wherein the user data is provided at the host by executing a host application that interacts with a client application executing on the UE, the client application being associated with the host application.

Embodiment 45. A communication system configured to provide an over-the-top service, the communication system comprising:
a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform the following operations to transmit the user data from the host to the UE:
      transmitting (530) a first message to the second network node, the first message including:
         an indication of a first cell identifier configured by a third network node; and
         an indication that the second network node avoid using the first cell identifier; and
      receiving (540) a second message from the second network node, the second message including an indication of a second cell identifier.

Embodiment 46. The communication system of the previous embodiment, further comprising:
the network node; and/or
the user equipment.

Embodiment 47. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 48. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the following operations to receive the user data from the UE for the host:
   transmitting (530) a first message to the second network node, the first message including:
      an indication of a first cell identifier configured by a third network node; and
      an indication that the second network node avoid using the first cell identifier; and
   receiving (540) a second message from the second network node, the second message including an indication of a second cell identifier.

Embodiment 49. The host of the previous 2 embodiments, wherein:
the processing circuitry of the host is configured to execute a host application, thereby providing the user data; and
the host application is configured to interact with a client application executing on the UE, the client application being associated with the host application.

Embodiment 50. The host of the any of the previous 2 embodiments, wherein the initiating receipt of the user data comprises requesting the user data.

Embodiment 51. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host:
   transmitting (530) a first message to the second network node, the first message including:
      an indication of a first cell identifier configured by a third network node; and
      an indication that the second network node avoid using the first cell identifier; and
   receiving (540) a second message from the second network node, the second message including an indication of a second cell identifier.

Embodiment 52. The method of the previous embodiment, further comprising at the network node, transmitting the received user data to the host.

1. A method of operating a first network node, in a communications network that includes a second network node, the method comprising:
transmitting a first message to the second network node, the first message including:
an indication of a first cell identifier configured by a third network node; and
an indication that the second network node avoid using the first cell identifier; and
receiving a second message from the second network node, the second message including an indication of a second cell identifier.

2. The method of claim 1, wherein the indication that the second network node avoid using the first cell identifier comprises a request that the second network node assign the second cell identifier.

3. The method of claim 1, wherein the first cell identifier and the second cell identifier each comprises a new radio, NR, cell global identity, CGI.

4. The method of claim 1, wherein at least one of:
the first message comprises a F1 SETUP REQUEST message and the second message comprises a F1 SETUP RESPONSE message;
the first message comprises a GNB-DU CONFIGURATION UPDATE message and the second message comprises a GNB-DU CONFIGURATION UPDATE ACKNOWLEDGE message;
the first message comprises a GNB-CU CONFIGURATION UPDATE message and the second message comprises a GNB-CU CONFIGURATION UPDATE ACKNOWLEDGE message; and
the second message comprises a radio resource control, RRC, signal.

5-7. (canceled)

8. The method of claim 1, wherein the first message includes an information element, IE, that includes the indication of the first cell identifier and the indication that the second network node avoid using the first cell identifier, and
wherein the IE is included in at least one of:
at an end of the first message;
each item of a Served Cells List IE; and
a Served Cell Information IE.

9. The method of claim 1, wherein the indication of the second cell identifier is included in a Cells to be Activated List Item IE.

10. The method of claim 1, further comprising:
receiving instructions from the third network node indicating that the second network node is responsible for assigning the second cell identifier.

11. The method of claim 10, further comprising:
receiving instructions from the third network node indicating the first cell identifier.

12. The method of claim 1, further comprising:
transmitting a third message to the third network node, the third message including a clarification added to at least one of:
a cellLocalID of NRCellDU to indicate in CU-based NR CGI allocation; and
a pLMNInfoList of NRCellDU to indicate in CU-based NR CGI allocation.

13. The method of claim 1, wherein the first network node is configured to provide a distributed unit, DU,
wherein the second network node is configured to provide a central unit, CU,
wherein the third network node is configured to provide an operation and maintenance, OAM, and
wherein the DU comprises a mobile integrated access and backhaul DU, mIAB-DU.

14. (canceled)

15. A method of operating a second network node, in a communications network that includes a first network node, the method comprising:
receiving a first message from the first network node, the first message including:
an indication of a first cell identifier configured by a third network node; and
an indication that the second network node avoid using the first cell identifier; and
transmitting a second message to the first network node, the second message including an indication of a second cell identifier.

16. The method of claim 15, wherein the indication that the second network node avoid using the first cell identifier comprises a request that the second network node assign the second cell identifier.

17. The method of claim 15, wherein the first cell identifier and the second cell identifier each comprises a new radio, NR, cell global identity, CGI, and
wherein the indication of the second cell identifier is included in a Cells to be Activated List Item IE.

18. The method of claim 15, wherein at least one of:
the first message comprises a F1 SETUP REQUEST message and the second message comprises a F1 SETUP RESPONSE message;
the first message comprises a GNB-DU CONFIGURATION UPDATE message and the second message comprises a GNB-DU CONFIGURATION UPDATE ACKNOWLEDGE message;
the first message comprises a GNB-CU CONFIGURATION UPDATE message and the second message comprises a GNB-CU CONFIGURATION UPDATE ACKNOWLEDGE message; and
the second message comprises a radio resource control, RRC, signal.

19-21. (canceled)

22. The method of claim 15, wherein the first message includes an information element, IE, that includes the indication of the first cell identifier and the indication that the second network node avoid using the first cell identifier, and
wherein the IE is included in at least one of:
at an end of the first message;
each item of a Served Cells List IE; and
a Served Cell Information IE.

23. (canceled)

24. The method of any claim 15, further comprising:
receiving (610) instructions from the third network node indicating that the second network node is responsible for assigning the second cell identifier.

25. The method of claim 15, wherein the first network node is configured to provide a distributed unit, DU,
wherein the second network node is configured to provide a central unit, CU,
wherein the third network node is configured to provide an operation and maintenance, OAM, and
wherein the DU comprises a mobile integrated access and backhaul DU, mIAB-DU.

26. (canceled)

27. A method of operating a third network node, in a communications network that includes a first network node and a second network node, the method comprising:
determining a first cell identifier;
transmitting an indication of the first cell identifier to the first network node; and
receiving an indication that the first cell identifier is invalid.

28. The method of claim 27, wherein receiving the indication that the first cell identifier is invalid comprises receiving an indication of a second cell identifier assigned by the second network node.

29. The method of claim 27, wherein the first network node is configured to provide a distributed unit, DU,
wherein the second network node is configured to provide a central unit, CU,
wherein the third network node is configured to provide an operation and maintenance, OAM, and
wherein the DU comprises a mobile integrated access and backhaul DU, mIAB-DU.

30-33. (canceled)
